(19) United States
(12) Patent Application Publication
(10) Pub. No.: US 2015/0271417 A1
(43) Pub. Date: Sep. 24, 2015

(54) TV SYSTEM WITH IMPROVED VIDEO SWITCHING CAPABILITIES, AND ASSOCIATED TV ENVIRONMENT, SERVER AND TERMINAL

(71) Applicant: JBINVESTISSEMENTS, PARIS (FR)

(72) Inventors: Yamine BENABDALLAH, LATTES (FR); Aidi RIAD, BEAUVAIS (FR)

(73) Assignee: JBINVESTISSEMENTS, PARIS (FR)

(21) Appl. No.: 14/218,762

(22) Filed: Mar. 18, 2014

(51) Int. Cl. H04N 5/268; H04N 21/2665; H04N 21/462; H04N 21/4782; H04N 21/422; G06F 3/0488; H04N 21/478; H04N 21/647; H04N 21/482

(52) U.S. Cl. CPC H04N 5/268; H04N 21/647; H04N 21/2665; H04N 21/4622; H04N 21/482; H04N 21/42203; G06F 3/0488; H04N 21/4781; H04N 21/4782

(57) ABSTRACT

A TV system with improved video switching capabilities is described. The system has: a TV set with at least one high-definition digital video and control input, a first content-providing unit connected to a network for providing high-definition video contents to the TV set, a second content-providing unit connected to a network for providing alternative high-definition video contents to the TV set, a video switching unit having inputs connected to outputs of the first and second content-providing units, a communicating user terminal provided with a user interface, a first network communications channel between said user terminal and said switching unit, and a second network communications channel between and external server and said switching unit, wherein said video switching can be performed remotely either by action of said user terminal, or by a switching command received from said server. Associated TV environment, server and terminal are also described.

### FIELD

This disclosure refers to consumer television systems and more particularly to the switching of the available video streams to the television set.

### BACKGROUND

Many TV viewers find traditional advertisements annoying. Thus, more and more viewers use the web on their smartphones or on their tablets (second display functionality) while keeping their television on, in particular during the TV ads. It is observed that 70% of the viewers visit their social networks on a second device (smartphone, tablet) during a commercial break.

Solutions have been proposed to allow the viewers to avoid the commercial breaks.

In the closest state of the art, the TIVO Box® contains a conventional hard-disk digital video recorder. It receives a video signal that is processed by an algorithm adapted to detect advertisements. In this way, this video signal can be fragmented taking into account the commercial breaks, released from these breaks and stored on the hard disk. This technique thus enables the user to have access to commercial-free content, but with a time-delayed broadcasting.

The algorithms for advertisement detection have been the subject of many researches among which Bo Zhang, Jiancheng Zou, Bo Xu “Context-dependent audio-visual and temporal features fusion for TV commercial detection”, Circuits and Systems (ISCAS), 2013 IEEE International Symposium; A.Albiol, M.J.Ch, F.A.Albiol and L.Torres, Detection of TV commercials, Proc. of ICASSP, 2004; D. Sadlier, et al, “Automatic TV Advertisement Detection from MPEG Bitstream,” Intl Conf on Enterprise Information Systems, Setubal, Portugal, 7-10 Jul. 2001.

On the other hand, this technique of advertisement detection and removal has the following disadvantages:
it does not provide an alternative content adapted to a break of a few minutes;
the TV operators integrate minute variations to the video signal to affect the signal processing; consequently, this technique requires:
   for the user: regular updates to maintain the reliability of the processing; and since they take place over landline connection, in practice they are not operational before a few days;
   for the Tivo Box® operator: regular updates of the algorithms for commercial break identification;
it requires a cumbersome installation, particularly when the phone wall socket is remote from the television set.

Other known solutions offer more personalized advertising, in particular by making use of the Internet infrastructure, or multi-screen systems:
the “Freebox”® is a box enabling the user to access the Internet and includes an environment that is adapted to video applications such as YouTube®;
Google TV® offers a more comfortable browsing experience thanks to specialized browsers and to a remote control provided with an alphanumeric keyboard;
Spotlight Gallery®, used on Google TV®, offers Chrome®-based applications specifically developed for Google TV®, for example games that enable the use of a smartphone; for instance, the game Poker Fun® displays the poker table on the TV and the playing cards on the smartphone.

Finally, other solutions provide a switching between different HDMI video sources, such as KAM-5-1HDM 10 of Kamatec®. With this switching unit, the user selects one HDMI source among five by means of a specific remote control unit.

All these solutions have at least one of the following drawbacks:
a degradation of content quality: truncated contents, undesirable insertions, lack of copyright control, etc.
requirement of an additional remote control unit.
requirement of tedious operations by the user: change in the wiring, need of several handling operations to switch from TV to the Web and back again, etc.
the inhibition of some TV channels: for instance, the presence of Google TV® can be detected by a conventional box (set-top box); since this box is provided with decryption keys for some channels, it blocks the transmission of the corresponding video signal on its HDMI video interface, or it replaces it with a video display such as <<Please disconnect your Google TV>>; the user is then obliged to change the wiring of his television set; similarly, with the Xbox One® box, most of the TV channels are blocked.

### SUMMARY

There is, therefore, a need to replace on the TV set the advertising slots broadcasted by the TV operators by an alternative content such as a Web service without the user having to change the wiring or without any other tedious handling.

For that purpose, several embodiments of the present disclosure provide a TV system provided with improved video switching capabilities, said system comprising:

a TV set provided with at least one high-definition digital video and control input,

a first content-providing unit connected to a network for providing high-definition video contents to the TV set,

a second content-providing unit connected to a network for providing alternative high-definition video contents to the TV set,

a video switching unit having inputs connected to outputs of the first and second content-providing units,

a communicating user terminal provided with a user interface,

a first network communications channel between said user terminal and said switching unit,

a second network communications channel between and external server and said switching unit, wherein said video switching can be performed remotely either by action of said user terminal, or by a switching command received from said server.

Preferred but non-limiting aspects of this system may include the following features, taken individually or in any technically compatible combinations:
said user terminal comprises a sound recognition circuit capable of recognizing a specific sound type collected by a terminal microphone, and said action on the user terminal is the generation of a sound according to said type;
said user terminal comprises a touch screen, and said action on the user terminal comprises a specific keying action on the touch screen;
the first content providing unit is a TV box provided with wireless communications network generation circuitry, and said second content-providing unit is a PC dongle;
said second content providing unit and said switching unit are provided in a single physical unit having a single video and control output for the TV set;
said first network communications channel between said user terminal and said switching unit relies on the wireless network generated by said TV box;
said switching command from said server is a collaboratively-generated by detection of states of a plurality of such TV systems connected to said server;
said user terminal comprises means for selecting a content-generating mode of said second content providing-unit via said first network communications channel;
said mode is selected among a plurality of modes including a gaming mode where said user terminal is used as a game input device, a gallery mode where said user terminal is used as a source of information for display on the TV set, and a Web mode where said user terminal is used as an input device for browsing;
said video switching is performed automatically in response to a switching command from said server;
said video switching is performed only after a switch-ready command has been received from said server and a user-generated switching action has been received by said system.

Other embodiments of the present disclosure further provide a TV environment, comprising a plurality of TV systems as defined above and said external server, all TV systems being connected to said TV server via respective second network communications channels.

According to another aspect, the present disclosure provides server for switching a TV system as defined above, comprising a plurality of network input for periodically receiving state and action data from a plurality of such TV systems, computing means for approximating from said data start times and end times for commercial breaks on a plurality of TV channels, and means for generating switching commands or switch-ready commands, on a channel-by-channel basis, to said plurality of TV systems.

Still another aspect of the disclosure provides a communicating user terminal, comprising a user interface, a processing unit and a memory, and a communications circuitry capable of establishing a wireless communications channel with a TV system as defined, said terminal including means for generating and transmitting through said channel to the TV system:
mode setting signals for the second content-providing unit of said system,
user interface input signals for said second content-providing unit, said signals being adapted to the mode types,
switching signals for the video switching unit of said TV system.

Preferred but non-limiting aspects of this terminal include the following features, taken individually or in any technically compatible combinations:
said mode setting signals include addressing signals for content sources.
said user interface input signals selectively include gaming signals and content browsing signals depending on the mode of the second content-providing unit.
said switching signals comprise manual switching signals and switch-confirmation signals.
the terminal further comprises a sound recognition circuitry for selectively generating a manual switching signal or a switch confirmation signal.

### BRIEF DESCRIPTION OF THE DRAWINGS

Other aims, features and advantages of the disclosure shall appear more clearly from the following detailed description of a preferred embodiment thereof, made with reference to the appended drawings, in which:

FIG. 1 depicts television equipment comprising a signal switch according to the disclosure,

FIG. 2 diagrammatically shows the display of a viewer's smartphone, that enables him to parameterize services and to control the signal switch of the disclosure, and different possible states that can be taken by the a content providing unit of the disclosure in response to the smartphone,

FIG. 3 is a flowchart showing the control process of the signal switch by a user's noise,

FIG. 4 is a flowchart showing the control process of the signal switch by use of advertisement detection by a users' community, and

FIG. 5 is a flowchart showing the control process of the signal switch by advertisement detection by the users' community and remote control action by the user.

### DETAILED DESCRIPTION

As a preliminary remark, it will be noted that certain of the reference signs used in the description below do not have counterparts in the drawings, but are nevertheless used for convenience purposes.

### 1) Components

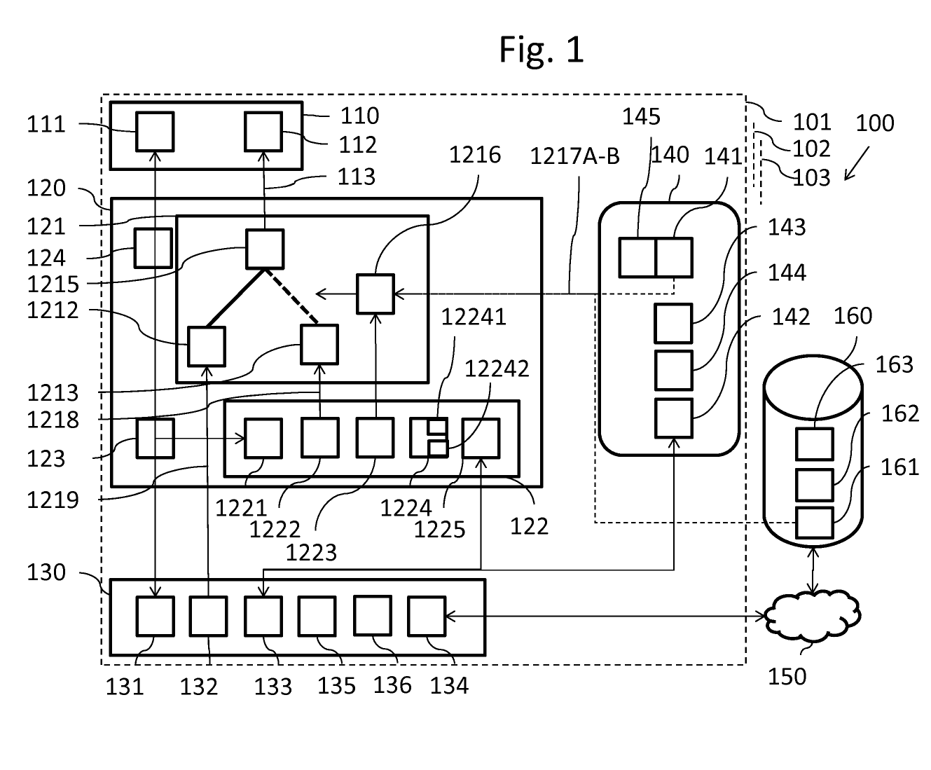

Referring to FIG. 1, a TV environment 100 comprises a set of television systems 101-102-103, each of them comprising at least one television set 110, a switch box 120, a content-providing unit or box 130 and a smartphone 140.

The television set 110 comprises an interface, in the present case a HDMI interface, having a control interface 111 and a video interface 112. The video signal 113 is displayed on a TV screen, not shown. The control interface 111 comprises the control signals HPD, CEC, HDCP, DDC data, DDC CLOCK as defined in the HDMI standard. The video interface 112 comprises the identified video, audio and synchronization TMDS signals CLOCKA/DATA A0/A1/A2 or CLOCKB DATAB0/B1/B2, and CLOCKOUT/DATA OUTO/1/2 as defined in the HDMI standard.

The switch box 120 comprises a switch 121, a content-providing unit or PC Dongle 122 such as an Android Dongle®, an input control interface 123 and an output control interface 124, these interfaces being defined again here by the HDMI standard.

This switch 121 is primarily made on the basis of an integrated circuit for switching between two signal ports, in this example HDMI ports, for example Fairchild® FSHDMI08®. This switch 121 comprises two input video interfaces 1212 and 1213 and one output video interface 1215. This switch 121 also comprises a controlled switch 1216 that switches between two stable positions. In the first position 12161, this controlled switch 1216 establishes a connection between the input video interfaces 1212 and the output video interfaces 1215 and carries out a disconnection between the video interfaces 1213 and 1215. Conversely, in the second position 12162, the connection is established between the input video interfaces 1213 and the output video interfaces 1215, and the disconnection is carried out between the video interfaces 1212 and 1215. This controlled switch 1216 is essentially built-in into the Fairchild® circuit, but it also comprises for the implementation needs a NI gate, for example an integrated circuit Rohm® BU4S01G2, connected to the legs 32 and 42 of the Fairchild® circuit. This NI gate enables to receive a binary input, to duplicate it on the leg 42 of the Fairchild® circuit and to invert it on the leg 32. This binary command thus results into the switching of the controlled switch 1216 as well as the switching of the switch 121.

The PC Dongle 122 is, for example, a commercially available Rikomagic® mk802 box. This PC dongle 122 comprises a HDMI output port composed of a control interface 1221 and of a video interface 1222 according to the HDMI standard described above. This control interface 1221 reads in particular the reference of the channel 1311 being broadcast thanks to the CEC protocol of the HDMI standard and can calculate the difference between two successive references to deduce that, when this difference is of 1 or of −1, the user pressed the <<Channel+1>> or <<Channel −1>> key respectively of its remote control 136. The PC dongle 122 also comprises a GPIO port 1223 that delivers a binary logic signal, an operating system 1224 that manages the interfaces 1221-1222-1223-1225 and that comprises application software and a Wi-Fi interface 1225.

The box 130 is a television electronic box, such as the one traded in France under the name Freebox®. This box 130 comprises a HDMI output port composed of a control interface 131 and of a video interface 132 according to the HDMI standard described above. In particular, this control interface 131 indicates the reference (ID) of the channel 1311 that is being broadcast at the video interface 132. This box 130 also comprises a Wi-Fi network generator 133 equipped with a Wi-Fi port, not shown, which enables a wireless connection with the PC dongle 122. Box 130 further comprises an operating system 135 that manages the interfaces 131-132-133-134 and that comprises application software, an internet interface 134 such as an ADSL port, a remote control 136 enabling in particular the user to change the channel by means of numeric keys or of the <<Channel+1>> and <<Channel −1>> keys.

The smartphone 140 comprises an operating system 141 and a Wi-Fi interface 142 allowing the establishment a wireless connection between the smartphone 140 and the PC dongle 122 via the Wi-Fi network generator 133.

Furthermore, the system 100 comprises a server 160 comprising an operating system 161, a statistical base 162 and an advertising base 163, the operating system being connected to the box 130 via the internet network 150 and the internet connection interface 134, to the PC dongle 122 and to the smartphone 140 via the Wi-Fi network generator 133 and the Wi-Fi interfaces 1225 and 14

### 2) Switch Command

The control interfaces 131, 1221, 123, 124 and 111 are connected with each other in parallel. It is thus possible, in particular at the PC dongle 122, to read the information exchanged between the box 130 and the television set 110.

The smartphone 140 can send a switch command 1217A to the switching box 120 according to the following command string: the operating system 141 generates this switch command 1217A and transmits it to the PC dongle 122 via the Wi-Fi server 133 and the Wi-Fi interfaces 142 and 1225 and thanks to the client/server communications programs 12241-1411 described below. This switch command 1217A is then copied by the operating system 1224 from the Wi-Fi interface 1225 onto the GPIO port 1223. The GPIO port 1223 delivers a binary logic signal and sends it to the controlled switch 1216.

Similarly, the server 160 can send a switch command 1217A to the switching box 120 according to the following command steps: the operating system 161 generates this switch command 1217A and transmits it to the box 130 via the Internet network 150 and the Internet interface 134. The operating system 135 of the box 130 copies this switch command 1217A and transmits it to the PC dongle 122 via the Wi-Fi server 133 and the Wi-Fi interface 1225. This switch command 1217A is then transmitted to the controlled switch 1216, as indicated above.

Moreover, the video interfaces 132 and 1222 are respectively connected to the two input video interfaces 1212 and 1213 of the switch 121. The controlled switch 1216 establishes a connection of the output video interface 1215 with a selected one of the two input video interfaces 1212 and 1213. The output video interface 1215 is connected to the video interface 112 for the display of the video signal 113 on the screen of the television set 110.

It is thus possible to display on the television set 110 either the video signal 1219 coming from box 130 via the video interface 132, or the video signal 1218 coming from the PC dongle 122 via the video interface 1222, depending on the switch command 1217A transmitted either by the smartphone 140, or by the server 160.

### 3) “Switch-Ready” Command

The server 160 can also send a switch-ready command 1217C, that is not represented, to the switching box 120 according to the following command steps: the operating system 161 of server generates this switch-ready command 1217C and transmits same to box 130 via the internet network 150 and the internet interface 134. The operating system 135 of the box 130 copies this switch-ready command 1217C and transmits it to the PC dongle via the Wi-Fi network maintained by Wi-Fi network generator 133 and the Wi-Fi interface 1225. Upon receipt, the PC dongle 122 is enters into a switch-ready mode in which it waits for the reception of a “Channel+1” command by the remote control 136 of the box 130. This command is calculated by the command interface 1221, as described above. At the reception of this “Channel+1” command, a switch command is sent to the controlled switch 1216, as indicated above.

4) Addressing command

The video signal 1218 of the PC dongle 122 can come from different sources depending on an addressing command 1217B issued by smartphone 140 via the Wi-Fi network 142-133-1225.

Thanks to a human-machine interface 144 described below, the smartphone 140 is in a particular mode among different modes 230-231-232, each mode being associated to a respective source address 2301-2311-2321 (e.g. a URL) for the PC dongle. When the smartphone 140 transmits a switch command 1217A, this command is accompanied by an addressing command 1217B that indicates to the PC dongle 122 this particular address 2301-2311-2321.

The display management program 12242 mixes two information flows or contents, as described below. The first flow is the one accessed by the PC dongle 122 at this particular address, for example that of Facebook® on the Internet 150, that of a photo gallery on the internal memory of the smartphone 140, that of an online video game requiring the use of Internet 150 and of the internal memory of the smartphone 140. The second flow has the same origin as the one that feeds the video interface 132 of box 130. The reference of the corresponding television channel is transmitted by the command interface 131 and is read by the PC dongle 122 by means of its command interface 1221. This reference is thus used by the PC dongle 122 to access to this television channel via the Wi-Fi network 1225-133.

4) Resolution initialization process

During the switching on of the television set 110 and of the box 130, the HDMI standard provides a protocol for the definition of resolution, i.e. the display format on the screen of the television set 110. Thus, a first HPD request is sent by the television set 110 to the box 130 via the command interfaces 111-123-124-131 that confirms its connection on the same channel, then makes a DDC request to obtain the resolution of the television set 110. Upon receipt, the box 130 adjusts the transmission format of its video signal 1219 to adapt it to this resolution.

The command interface 1221 of the PC dongle 122 is connected to the command interfaces 123 and 131. Thus, the PC dongle 122 can read the resolution definition protocol above and adjust accordingly the transmission format of its video signal 1218 to adapt it to this resolution.
5) Dongle/smartphone communications

The PC dongle 122 is supplied with an operating system 1224 such as Android®.

A client/server communications program 12241 is associated to this operating system 1224 to manage the communication between the PC dongle 122, as a server, and the smartphone 140, as a client. For this purpose, the client program allows the personalization and control of the server program via a set of commands comprising, on the one hand, the navigation commands: up, down, right, left, input, position xy of the pointer, click, positions xyzt of two fingers on a touchscreen, gyroscope coordinates, etc. and, on the other hand, data commands: HTML address, command line, data etc. This type of program is known from the skilled in the art. It is often developed with the protocols JSON® of JSON-RPC Working Group®, and Node.js®. It is to be found in the open source application XBMC®, developed by Team XBMC®, implemented in Android®, Xbox One® or the game Multeor®.

6) Video signal generation

A display management program 12242 is also associated to this operating system 1224 to generate the video signal 1218 on the basis of information flows coming from different web, video, image or sound sources, that can be mixed with each other. This display management program 12242 is known to the skilled person. This program may be for instance the application “YouTube for Android®” that enables in particular to embed a television channel into a web content in PIP mode (Picture in Picture).

7) Sound command recognition

The smartphone 140 is supplied with an operating system 141, such as Android®.

A sound (preferably a whistle sound) recognition program 143 is added to the smartphone 140 and cooperates with the operating system 141. Sound recognition programs are known to the skilled person; cf. for instance Lopes, G., Ribeiro, A. F., & Carvalho, P. (2010). “Whistle sound recognition in a noisy environment”, Mellinger, D. K., Martin, S. W., Morrissey, R. P., Thomas, L., & Yosco, J. J. (2011), “A method for detecting whistles, moans, and other frequency contour sounds”, The Journal of the Acoustical Society of America, 129, 4055. This program 143 is parameterized so as to recognize a characteristic noise perceived by the microphone of the smartphone 140, such as a whistle or a snap of fingers.

8) Initialization of the smartphone modes

A human-machine interface 144 also cooperates with the smartphone operating system 141.

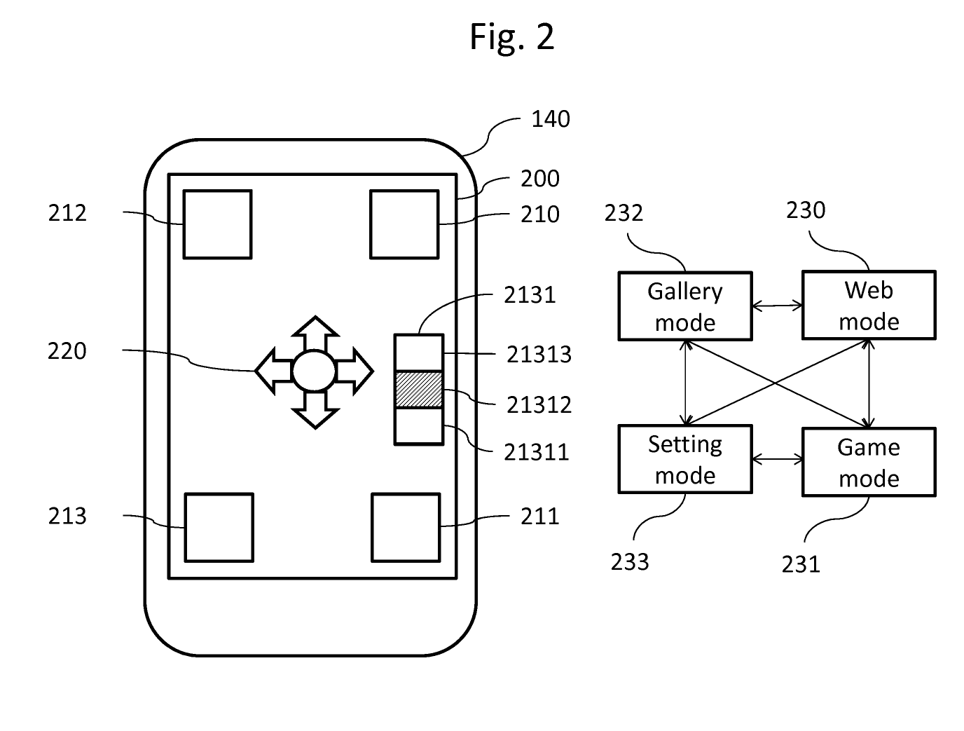

Referring to FIG. 2, the display 200 of the smartphone 140 displays the pages generated by the human-machine or user interface 144. The home page comprises control buttons, among which a web button 210, a video game button 211, a photo gallery button 212, a setting button 213 and navigation buttons 220.

By activating the setting button 213, the user of the smartphone 140 can set the latter into the setting mode 233. By activating the gallery button 122, the smartphone enters into a Gallery mode and the user interface displays a menu that enables the user to select the HTML address or the internal memory address of a folder of photos by means of the navigation buttons 220. He thus creates an association of the gallery button 212 to this address 2321. Similarly, the user can set the Web mode by associating the web button 210 to a web page address 2301, for example Facebook®, Twitter® or Gmail®, and set the (video) Game mode by associating the video game button 211 to the address 2311 of an application. After the smartphone has left the Setting mode, the activation of the buttons 210-211-212 by the user sets the smartphone respectively into the web mode state 230, video game mode 231 or gallery mode 232, each of these modes being respectively associated to the address 2301, 2311 or 2321.

In the Setting mode, the user of the smartphone 140 also accesses an Advertising mode button 2131 that defines an Advertising mode which is superimposed on the other modes. This button 2131 has three positions: manual 21311, semi-automatic 21312 and automatic 21313. Depending on the position of this button 2131, the switch command 1217A or 1217C is sent by the smartphone 140 or by the server 160, as described below.

9) Command interface

A client/server communications program 1411 also cooperates with the smartphone operating system 141 and communicates with the client/server communications program 12241 of dongle 122.

By activating the navigation buttons 220 or by modifying the orientation of the smartphone 140, the smartphone user causes the transmission by the client program of commands among the set of commands described above. When the television set 110 displays a web page generated by the PC dongle 122, the user can thus browse in this page with the navigation buttons 220.

10) Statistical advertisement detection

Thanks to its command interface 1221, the PC dongle 122 can read from the command interface 131 the reference of the channel 1311 that is being broadcast by the video interface 132 of the box 130. It informs the server 160 thereof. Moreover, the smartphone 140 also informs the server 160 of the state of its advertising mode button 2131, of the transmitted switch commands 1217, of the modes 230-231-232 and of the associated addresses 2301-2311-2321.

By collecting this information from a plurality television systems 101-102-103, the server 160 generates a time-stamped statistical database 162 comprising at least the following fields: IDs of the television systems 101-102-103, reference of the channel 1311, advertising mode 2131, switch command 1217, mode of the smartphone 230-231-232, addresses 2301-2311-2321 associated to these modes.

A first processing action 1621 by the operating system 161 on database 162 enables to set a list 1622 of the television systems 101-102-103, the channel reference 1311 of which corresponds to a given reference and the button 2131 of which is in automatic mode position.

A second processing action 1623 by the operating system 161 on database 162 enables to compute the number of switch commands per unit of time 1624 and per channel reference 1311.

A third processing action 1625 by the operating system 161 on database 162 enables to define the start 1626 and the end 1627 of a commercial break for each channel reference 1311. The start time 1626 is defined as the time when the number of switch commands per unit of time 1624 exceeds a first predefined threshold for a predefined channel reference. Since a subgroup of the viewers of this channel has a control window of the channel being broadcast in PIP mode, the end time 1627 is defined as the time when the number of switch commands per unit of time 1624 exceeds a second predefined threshold for the considered predefined channel.

A fourth processing action 1628 by the operating system 161 on database 162 enables to generate a list 1629 of the television systems 101-102-103, the channel reference 1311 of which corresponds to a defined channel reference and the smartphone 140 of which is in automatic mode 21313.

A fifth processing action 1630 by the operating system 161 on database 162 enables to generate a list 1631 of the television systems 101-102-103, the channel reference 1311 of which corresponds to a defined channel reference and the smartphone 140 of which is in semi-automatic mode 21312.

11) Sound-actuated switching method

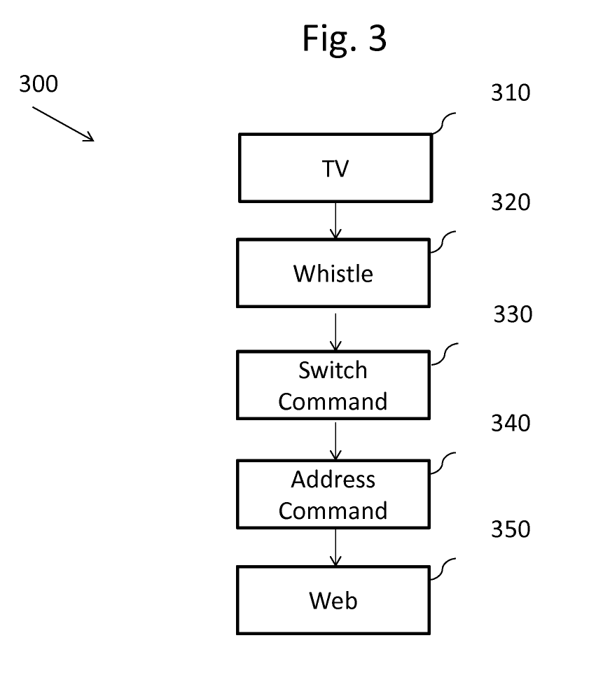

Referring now to FIG. 3, a process 300 enables the user of a smartphone 140 to cause, by whistling with his mouth, an alternative display in replacement of the advertisements on his television set according to the following steps:
in step 310, the television set 110 displays the video signal 113 outputted by the box 130, via the video interfaces 132, 1212, 1215 et 112, the controlled switch 1216 being set in its first position, as described above;
in step 320, the user whistles, the sound being captured by the microphone of the smartphone 140 and recognized by the sound recognition program 143;
in step 330, the smartphone 140 sends a switch command 1217A to the switch 121, according to the functional command steps described above;
in step 340, the smartphone 140 sends to the PC dongle 122 an address command 1217B that indicates the source address 2301-2311-2321 of an information flow;
in step 350, the display management program 12242 generates the video signal 1218 from the above address 2301-2311-2321, and the controlled switch 1216 is set to its second position.

12) Automatic switching method

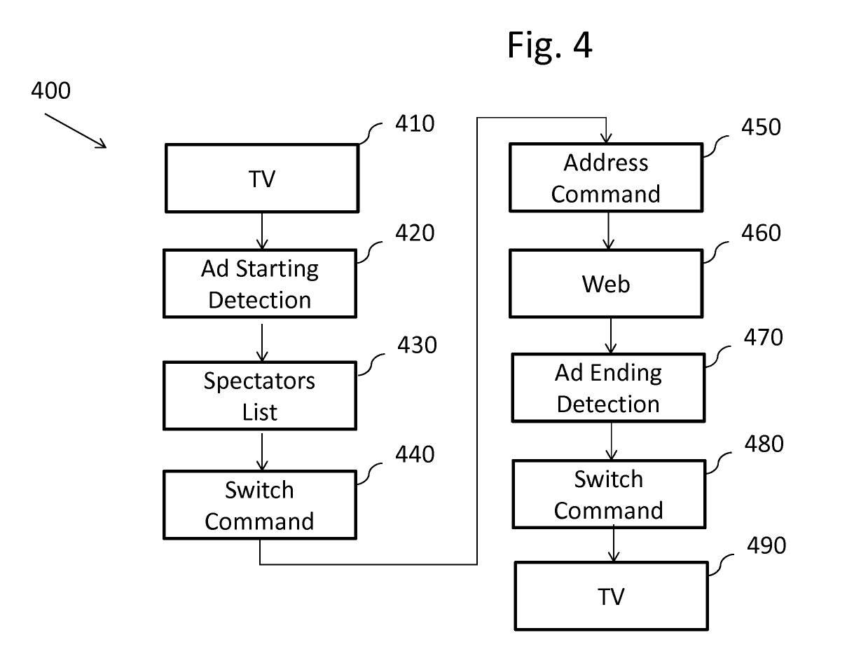

Referring to FIG. 4, the process 400 enables the server 160 to automatically cause an alternative display to the advertisements on the television set 110, thanks to the advertisements detection by the community of users, according to the following steps:
in step 410, the television set 110 displays the video signal 113 outputted from the box 130, via the video interfaces 132, 1212, 1215 et 112, the controlled switch 1216 being switched into its first position 12161, as described above;
in step 420, the server 160 detects the beginning 1626 of a commercial break for a defined channel reference thanks to the third processing action 1625 described above;
in step 430, the server 160 generates the list 1629 of the television systems 101-102-103 corresponding to this predefined channel reference and in semi-automatic mode 21313, thanks to the fourth processing action 1628 described above;
in step 440, the server 160 sends a switch command 1217A to the switch 121 of each television system 101-102-103 of this list 1629, according to the functional command string described above;
in step 450, the server 160 sends to the PC dongle 122 of each of the television systems 101-102-103 of this list 1629 an addressing command 12178 that indicates the address 2301-2311-2321 of an information flow;
in step 460, the display management program 12242 of each of these television systems 101-102-103 generates the video signal 1218 with this address 2301-2311-2321, and each corresponding controlled switch 1216 tilts into its second position 12162;
in step 470, the server 160 detects the end 1627 of a commercial break for this predefined channel reference thanks to the third processing action 1625 described above;
in step 480, the server 160 sends a switch command 1217A to the switch 121 of each of these television systems 101-102-103, according to the functional command string described above;
in step 490, the controlled switch 1216 of each of these television systems 101-102-103 is set to its first position 12161.

13) Semi-automatic switching method

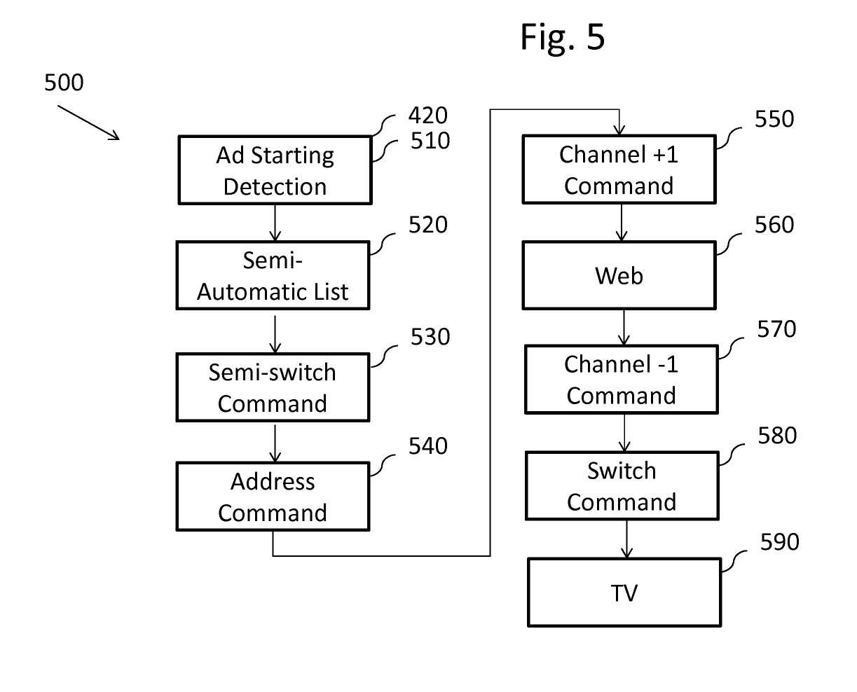

Referring to FIG. 5, the process 500 enables the user of a television system 101 who presses the [symbol] Channel+1 [symbol] key of his remote control 136, either to cause a change of channel when there is no advertisement, or to cause an alternative display in replacement of the advertisements on the television set 110, according to the following steps:
step 510 corresponds to step 420 of the method 400: during this step, the server 160 detects the start 1626 of a commercial break for a predefined channel reference thanks to the third processing action 1625 described above;
in step 520, the server 160 generates the list 1631 of the television systems 101-102-103 corresponding to this predefined channel reference and in semi-automatic mode 21312, thanks to the fifth processing action 1630 described above;
in step 530, the server 160 sends a switch-ready command 1217C to the PC dongle 122 of each of these television systems 101-102-103 of this list 1631, according to the functional command string described above;
in step 540, the server 160 sends to the PC dongle 122 of each of these television systems 101-102-103 of each list 1631 an addressing command 1217B that indicates the address 2301-2311-2321 of an information flow;
in step 550, the user of one of these particular television systems 101 presses a [symbol] Channel+1 [symbol] key of the remote control 136. This pressing of the key is detected by the command interface 1221 of the PC dongle 122, as described above;
in step 560, the display management program 12242 of this television system 101 generates the video signal 1218 with this address 2301-2311-2321, and the corresponding controlled switch 1216 is set to its second position 12162;
in step 570, the user of this television system 101 presses the [symbol] Channel −1 [symbol] key of the remote control 136. This pressing of the key is detected by the command interface 1221 of the PC dongle 122, as described above;
in step 580, the PC dongle 122 of this television system 101 sends a switch command 1217A to the switch 121;
in step 590, the controlled switch 1216 is set to its first position 12161.

14) Smartphone—Remote control

In a variant embodiment, the smartphone 140 implements an application that replaces the actions by remote control 136.

Remote control emulation by a smartphone is known to the skilled person. Google Play® proposes, for example, the FreeTelec® software, developed by Roro®, that enables to emulate the remote control of the Freebox® of Free® by implementing the Freebox® API. This emulation causes for instance the transmission by the command interface 131 of a channel reference 1311 that will be read by the PC dongle 122.

As an alternative, the smartphone 140 comprises an application 145 that, in addition to the emulation of the remote control 136, copies each command of this emulated remote control, for example, a change of channel, to simultaneously transmit it to the dongle 122 via the Wi-Fi server 133. Thus, the dongle 122 is directly informed of the actions of the emulated remote control without having to monitor the CEC protocol exchanged between the interfaces 131 and 111.

15) Variants and modifications

The switch 121 can be implemented on the basis of an integrated circuit between more than two HDMI ports, such as the ADV7623® circuit of Analog Devices®. This variant enables to connect additional content-generating devices such as Blu-Ray® players, multimedia boxes, etc. The human-machine interface 144 and the setting button 213 are then adapted to set more modes 230-231-232. The switch 121 can also be implemented on the basis of a SIL 9573 type or of 9575® type component, produced by Silicon Image® and implemented in the Insta Pre-vue® technology enabling to mix four video streams in PIP mode. In this case, the controlled switch 1216 comprises four positions 12161 to 12164 that define the main video stream, each position being associated to information indicating the presence, the positioning and the size of the three secondary video streams.

The box 130 is a decoder, a set-top box, a satellite terminal, a television cable terminal or a TNT tuner. This box usually comprises a Wi-Fi network generator 133 and an Internet interface 134, but these functions can be separate and communicate with each other by other connection types.

The smartphone 140 can be replaced by an electronic tablet such as an Apple iPad®, connected glasses such as Google Glass®, a connected watch such as Sony Smartwatch® or any terminal type that is equipped with a display and a Wi-Fi connection.

Each Wi-Fi connection can be replaced or completed by a Bluetooth® connection or by any other wireless connection technology.

The video signals 1218-1219 can originate from various sources such as the Internet network 150, the server 160, one of the smartphones 140 of the users via the Wi-Fi network 133. The operating systems 1224-135-141 can also mix several video streams originating from several sources. These applications are known from the skilled in the art, such as the Freebox TV Mobile® application and generally the [symbol] second display [symbol] commercial software.

The characteristic noise can be sensed by two or more microphones located in the smartphone(s) of the users, or in the PC dongle 122, or in the box 130, or in its remote control 136, or in any other equipment of the television system 101 equipped with a microphone. This characteristic noise is then sent by the Wi-Fi server 133 to the sound recognition program 143 that can be itself integrated into the smartphone 140 or the PC dongle 122.

In the semi-automatic method 500, the [symbol] Channel+1 [symbol] key of the remote control 136 that causes the switching operation can be replaced by any other key of this remote control 136.

In order to avoid any undesirable switching operation in the processes 300, 400 and 500, a security step, that is not represented, is preferably provided in which the user expressly accepts the mode of operation of these methods.

As a conclusion, the present disclosure innovatively combines various technical bricks, and in particular:
sound recognition techniques to enable a viewer to indicate the start of an advertisement by whistling.
the Internet to collect the viewers switching commands and to confirm the start of an advertisement by statistical processing.
PC dongles to develop an alternative television flow, to receive an advertising start signal from the social network and to transmit a switch command.
the controlled HDMI switches to receive this switch command between the signal of a television channel and that of a website.

Thanks to the combination of these technical features, the disclosure provides a HD-Video switch such as a HDMI switch that makes possible to the viewer, in particular, the switching of video stream by whistling or snapping a finger, the switching through detection of the TV advertisement by the community of viewers, the display of web services on the TV set in a single step and the display of web services by simply pressing the [symbol] Channel +1 [symbol] key or any other channel key of the remote control during the commercials.

Of course, the present invention is not limited to the described and shown embodiments, but the skilled person will be able to devise many variants and modifications within the scope of the appended claims.

1. A TV system comprising:
a TV set comprising at least one high-definition digital video and control input,
a first content-providing unit connected to a network for providing high-definition video contents to the TV set,
a second content-providing unit connected to a network for providing alternative high-definition video contents to the TV set,
a video switching unit having inputs connected to outputs of the first and second content-providing units,
a communicating user terminal provided with a user interface,
a first network communications channel between said user terminal and said switching unit, and
a second network communications channel between and external server and said switching unit,
wherein the video switching unit is configured to perform video switching between the high-definition video contents and the alternative high-definition video contents remotely either by action of said communicating user terminal, or by a switching command received from said server.

2. The TV system according to claim 1, wherein said user terminal comprises a sound recognition circuit capable of recognizing a specific sound type collected by a terminal microphone, and said action on the user terminal is the generation of a sound according to said type.

3. The TV system according to claim 1, wherein said user terminal comprises a touch screen, and said action on the user terminal comprises a specific keying action on the touch screen.

4. The TV system according to claim 1, wherein the first content providing unit is a TV box provided with wireless communications network generation circuitry, and said second content-providing unit is a PC dongle.

5. The TV system according to claim 4, wherein said second content providing unit and said switching unit are provided in a single physical unit having a single video and control output for the TV set.

6. The TV system according to claim 4, wherein said first network communications channel between said user terminal and said switching unit relies on the wireless network generated by said TV box.

7. The TV system according to claim 1, wherein said switching command from said server is a collaboratively-generated by detection of states of a plurality of such TV systems connected to said server.

8. The TV system according to claim 1, wherein said user terminal comprises means for selecting a content-generating mode of said second content providing-unit via said first network communications channel.

9. The TV system according to claim 8, wherein said mode is selected among a plurality of modes including a gaming mode where said user terminal is used as a game input device, a gallery mode where said user terminal is used as a source of information for display on the TV set, and a Web mode where said user terminal is used as an input device for browsing.

10. The TV system according to claim 1, wherein said video switching is performed automatically in response to a switching command from said server.

11. The TV system according to claim 10, wherein said video switching is performed only after a switch-ready command has been received from said server and a user-generated switching action has been received by said system.

12. A TV environment, comprising a plurality of TV systems according to claim 1 and said external server, each TV system being connected to said TV server via a respective second network communications channel.

13. A server for switching a TV system according to claim 1, comprising a plurality of network inputs for periodically receiving state and action data from a plurality of said TV systems,
computing means for approximating from said data start times and end times for commercial breaks on a plurality of TV channels, and means for generating switching commands or switch-ready commands, on a channel-by-channel basis, to said plurality of TV systems.

14. A communicating user terminal, comprising a user interface, a processing unit and a memory, and a communications circuitry capable of establishing a wireless communications channel with a TV system as claimed in claim 1, said terminal including means for generating and transmitting through said channel to the TV system:
mode setting signals for the second content-providing unit of said system,
user interface input signals for said second content-providing unit, said signals being adapted to the mode types, and
switching signals for the video switching unit of said TV system.

15. The terminal according to claim 14, wherein said mode setting signals include addressing signals for content sources.

16. The terminal according to claim 14, wherein said user interface input signals selectively include gaming signals and content browsing signals depending on the mode of the second content-providing unit.

17. The terminal according to claim 14, wherein said switching signals comprise manual switching signals and switch-confirmation signals.

18. The terminal according to claim 17, further comprising a sound recognition circuitry for selectively generating a manual switching signal or a switch confirmation signal.
